(19) United States
(12) Patent Application Publication
(10) Pub. No.: US 2018/0116454 A1
(43) Pub. Date: May 3, 2018

(54) Extendable Outdoor Cooking Grill

(71) Applicants: Thomas Vogds, Denton, TX (US); Terri Vogds, Denton, TX (US)

(72) Inventors: Thomas Vogds, Denton, TX (US); Terri Vogds, Denton, TX (US)

(21) Appl. No.: 15/342,571

(22) Filed: Nov. 3, 2016

(51) Int. Cl. A47J 37/07

(52) U.S. Cl. CPC A47J 37/0763

(57) ABSTRACT

An extendable outdoor cooking grill which is designed to be used in Kamado style outdoor cookers which enabless the grill master to move the top grill to permit access to other grills positioned below the top grill or to access the heat source of the outdoor cooker. The extendable cooking grill is comprised of a D-shaped outdoor cooking grill which is slidably connected to a seven sided top support member. The seven sided top support member is removably affixed to a frame which supports the seven sided top support member and D-shaped outdoor cooking grill in the Kamado style outdoor cooker.

### CROSS-REFERENCE TO RELATED APPLICATIONS

The instant application is a continuation in part of U.S. patent application Ser. No. 13/998,754 filed on Dec. 2, 2013 and which is incorporated herein by reference as if fully set forth.

### STATEMENT REGARDING FEDERALLY SPONSORED RESEARCH OR DEVELOPMENT

No part of the invention disclosed herein was the subject of federally sponsored research or development.

### THE NAMES OF THE PARTIES TO A JOINT RESEARCH AGREEMENT

None.

### REFERENCE TO A SEQUENCE LISTING

Not applicable.

### BACKGROUND OF THE INVENTION

Field

The field of the invention disclosed herein is the practice of outdoor cooking, grilling and/or smoking meat, vegetables and other foods over coals or an open fire. Specifically, the field of the invention disclosed herein is a tool which enables the grill master to slide the top grill out of the way to access the coal bed or other grills containing food.

### Description of the Related Art

The origins of cooking meats and other items over coals or an open flame probably extend to antiquity when earliest humans learned that game that had been hunted, killed and dressed took on a different taste and texture when left next to a fire or near coals. Meat began to be cooked on a stick or pole extending over the fire and rotated periodically. Some meats were buried in a pit with hot coals until done. Still other meats were smoked in a room with indirect heat and smoke cooking the meat. Gradually, the art of cooking over an open flame or coals has risen to the level of an art form in which complicated grills and exotic woods are used to cook the food. Today grills come in all shapes and sizes. Some grills are equipped with electric rotisseries to automatically turn the food while cooking. Other grills have temperature controls to monitor and maintain a steady heat for smooth and even cooking. Some grills are heated by natural gas. Other grills require charcoal or wood to provide the heat and cook the meat. One of the popular charcoal grills is the Kamado style cooker, such as The Big Green Egg®, a registered trademark of The Big Green Egg, Inc. Kamado style cookers are typically egg or oval shaped and made largely of ceramic, metal or other earth materials. Air vents located at the top and the bottom of Kamado style cooker control the amount of air which enters and leaves the grill, thereby regulating the heat intensity of the coals and/or fire. Charcoal, the primary fuel source, is added at the bottom of the Kamado style cooker and ignited to provide the heat source within the Kamado style cooker. The heat travels vertically in various amounts toward the top of the Kamado cooker and is dispersed throughout the inside of the Kamado cooker. How the grill master controls the rising heat and food placement impacts how fast or slows the food cooks in the Kamado style cooker.

This dispersal of the heat creates a temperature gradient which can be utilized by the grill master to cook foods faster or slower depending on where in the Kamado style cooker the food is placed. Problems associated with the design of the Kamado style cooker are: the amount of cooking space, the difficulty in cooking a variety of foods at different temperatures, the difficulty in removing food from the Kamado style cooker, the difficulty accessing the charcoal and changing cooking configurations within the Kamado style cooker during the cook. What is needed in the art is a tool for the Kamado style cookers which enables the grill master to conveniently and safely access grills located lower in the Komodo style cooker or to access the coal bed.

### BRIEF DESCRIPTION OF THE INVENTION

The invention disclosed herein is a tool for use with Kamado style cookers which enables the grill master to conveniently and safely access grills located lower in the Kamado style cooker or to access the coal bed. Specifically, the invention disclosed herein is a D-shaped grill with a frame designed and constructed to fit inside the Kamado style cooker and permit the top grill to slide away from the grill exposing the lower levels of the Kamado style grill. With this invention, the top grill can be safely moved out of the way of the grill master's access to the lower levels of the Kamado style grill.

### BRIEF DESCRIPTION OF THE SEVERAL VIEWS OF THE INVENTION

A better understanding of the extendable outdoor cooking grill disclosed herein may be had by examination of the drawing/figures attached hereto.

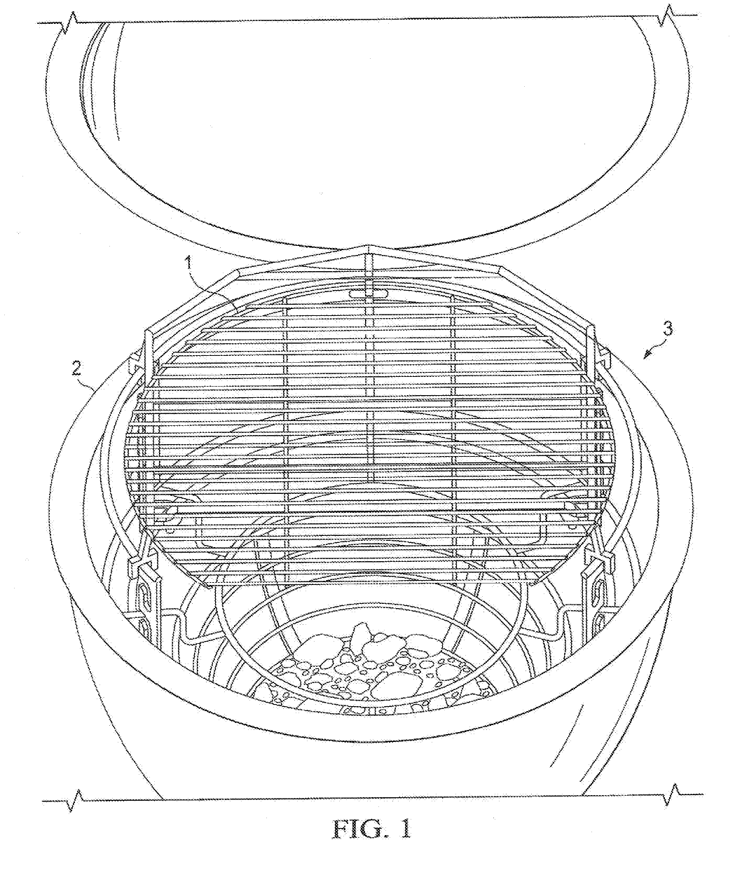

FIG. 1 is an environmental diagram of the extendable D-shaped grill in normal position;

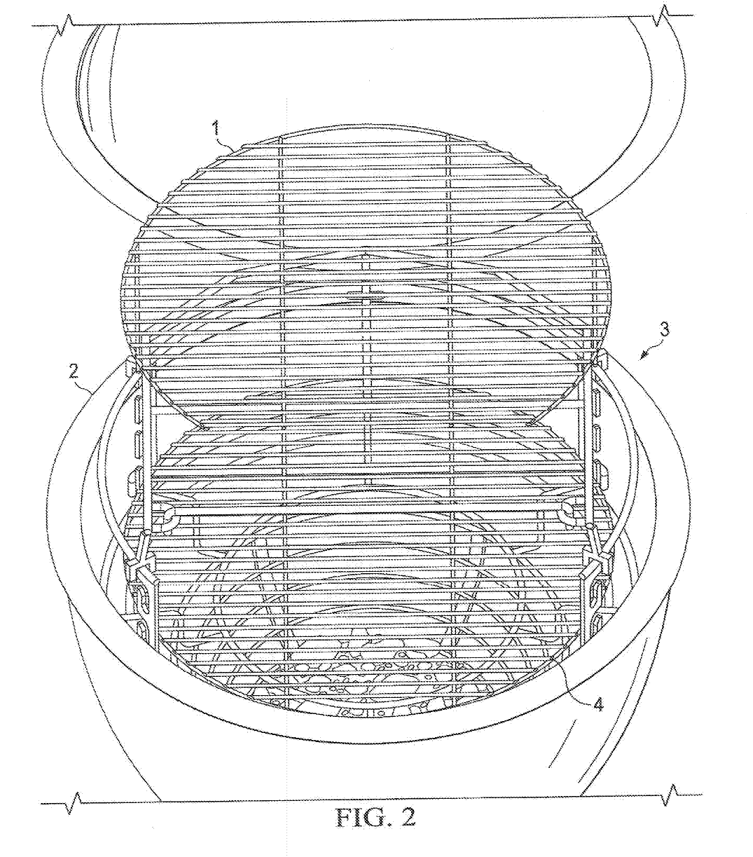

FIG. 2 is an environmental diagram of the D-shaped grill extended;

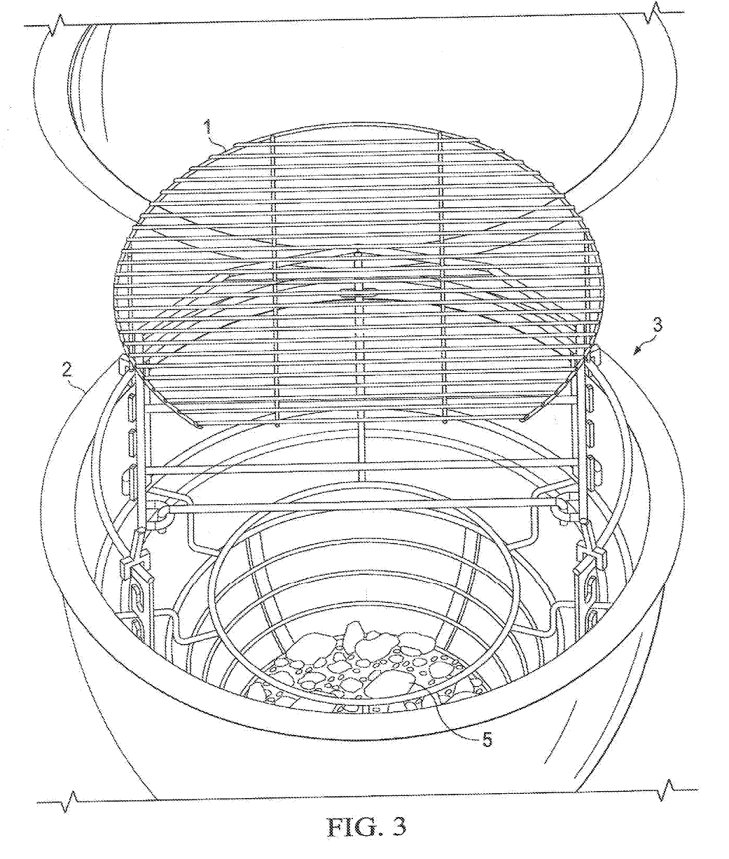

FIG. 3 is an environmental diagram of the D-shaped grill extended;

FIG. 4 is a top view of the D-shaped grill

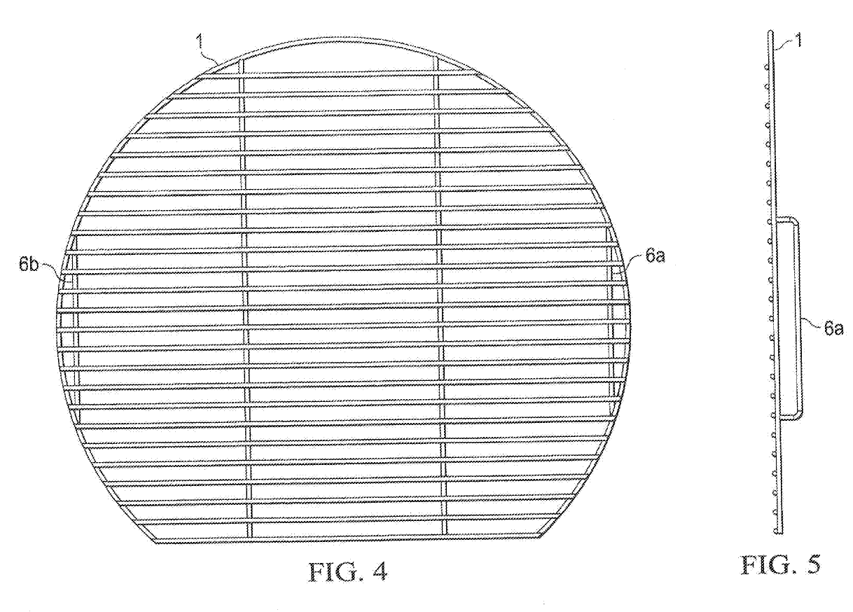

FIG. 5 is a side view of the D-shaped grill

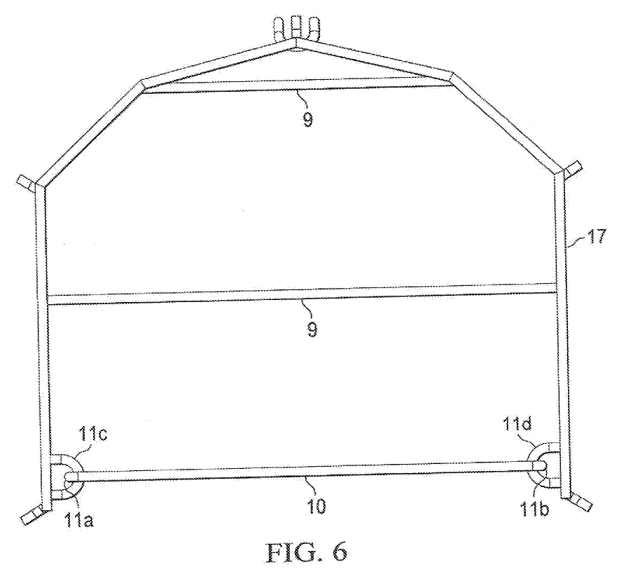

FIG. 6 is a view of the D-shaped grill frame.

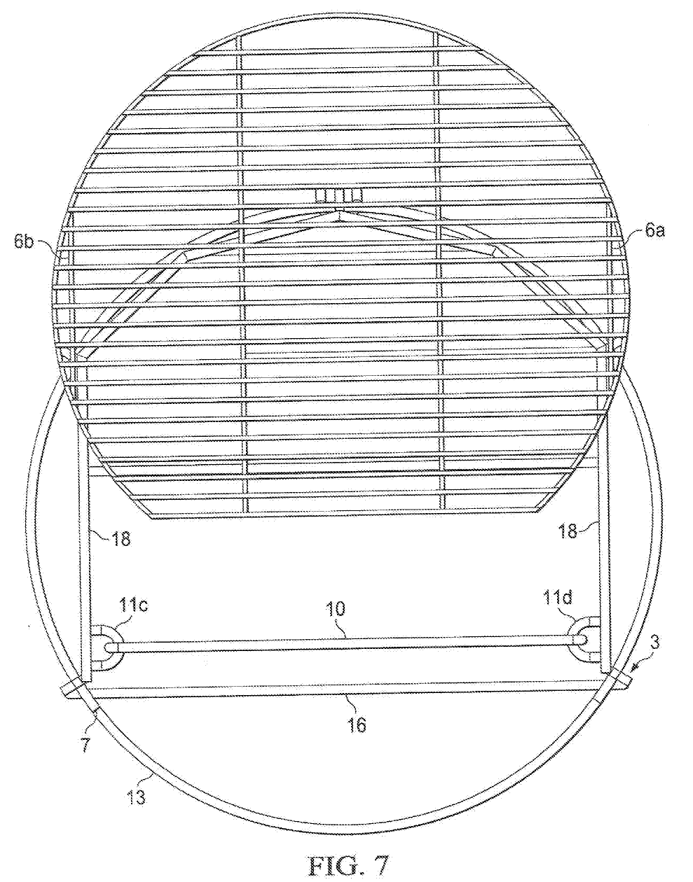

FIG. 7 is a view of the D-shaped grill mounted on the grill frame.

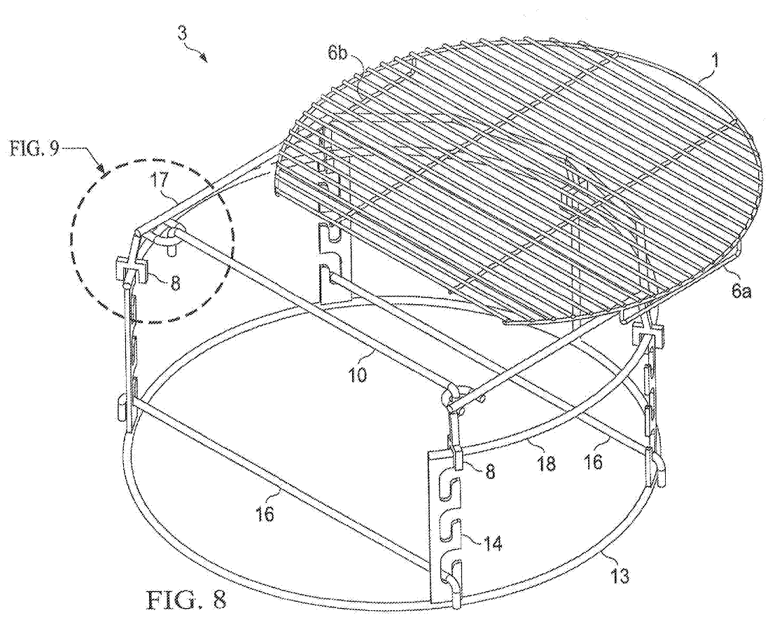

FIG. 8 is a top view of the D-shaped grill mounted on the grill frame.

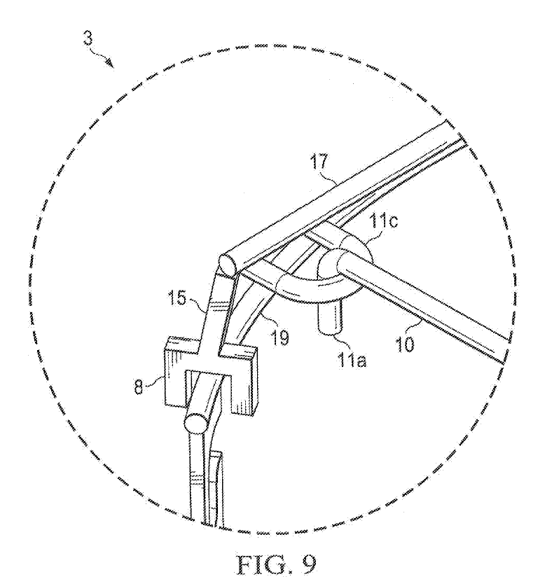

FIG. 9 is a diagram of the connection of the D-shaped grill with the grill frame

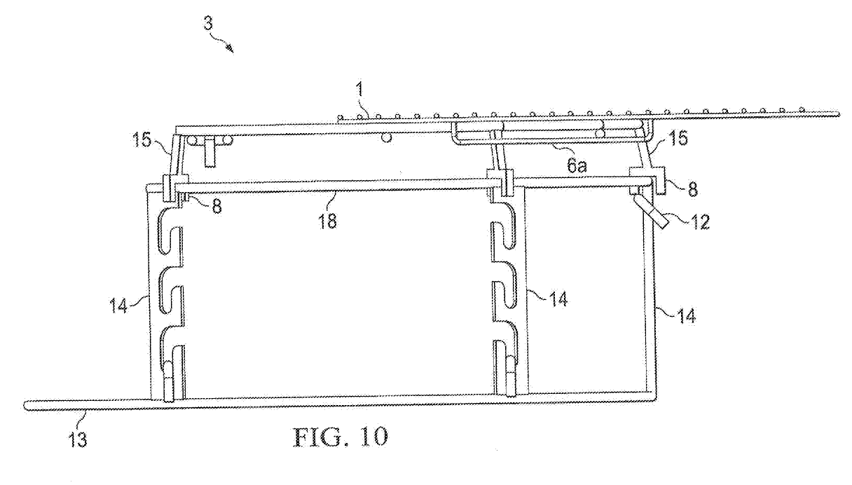

FIG. 10 is a side view of the connection of the D-shaped grill with the grill frame.

### DETAILED DESCRIPTION OF THE INVENTION

The invention disclosed herein is an extendable D-shaped outdoor cooking grill for Kamado style cooker. The D-shaped outdoor cooking grill sits on a frame inside of the Kamado style cooker which permits the grill master to move the D-shaped outdoor cooking grill out of the way for safe and convenient access to the lower levels of the Kamado style cooker.

The D-shaped outdoor cooking grill in normal operating position is shown in FIG. 1. The D-shaped outdoor cooking grill 1 sits on the frame 3 located inside of the Kamado style cooker 2. When the D-shaped outdoor cooking grill 1 is in the normal operating position, the food to be grilled is directly over the coals for optimum cooking. However, when the D-shaped outdoor cooking grill 1 is in normal operating position, access to the lower levels of the Kamado style cooker 2 is limited.

The D-shaped outdoor cooking grill 1 is designed and configured so as to permit the D-shaped outdoor cooking grill 1 to be extended out of the way to permit easy access to the lower levels of the Kamado style cooker 2 as shown in FIG. 2. The D-shaped cooking grill 1 slides along the frame 3 to permit access to the lower levels of the Kamado style cooker 2. As shown in FIG. 2, access to another grill surface 4 located below the D-shaped cooking grill 1 is enabled by sliding the D-shaped cooking grill 1 back along the frame 3. In this manner, food being cooked on the lower grill 4 is easily accessible to the grill master.

Access to the coals or other heat source used for cooking on the Kamado style cooker 2 is provided by the D-shaped outdoor cooking grill 1 disclosed herein. As shown in FIG. 3, the D-shaped outdoor cooking grill 1 is extended out of the way by sliding the D-shaped outdoor cooking grill 1 along the frame 3. In this configuration, the grill master now has easy access to the coals 5 located in the bottom of the Kamado style cooker 2.

As shown in FIGS. 4 and 5, in order to stabilize the D-shaped outdoor cooking grill 1 as it slides along the frame 3, a pair of brackets 6a and 6b positioned on opposite sides of the D-shaped outdoor cooking grill 1 are attached to the underside of the D-shaped outdoor cooking grill 1 and prevent the D-shaped outdoor cooking grill 1 from moving laterally across the frame (not shown) and falling off of the frame. In addition, a stop bar 7 is positioned on the underside of the D-shaped outdoor cooking grill 1 to prevent the grill master from extending the D-shaped outdoor cooking grill 1 too far horizontally and have the D-shaped cooking grill 1 off the back of the frame 3. The stop bar 7 also provides support and rigidity to the frame.

The top of frame 3 upon which the D-shaped outdoor cooking grill rests is a seven sided top member 17 which is attached to a lower ring (not shown) as shown in FIG. 6. At the front of the frame 3 is a cross member 10 with hooks 11a and 11b positioned on opposite ends of cross member 10. Cross member 10 attaches to both sides of seven sided top member 17 frame 3 by slipping hooks 11a and 11b into loops 11c and 11d. Loops 11c and 11d are connected to the underside of the seven sided top member 17 and located at the front of the seven sided top member 17. Cross member 10 is removable by lifting it off of the seven sided top member. When attached to the seven sided top frame 17, cross member 10 provides support and balance for larger grilling platforms. A plurality of cross members 9 extend between the two long sides of the seven sided top member 17 and are securely attached to opposite sides of the seven sided top member 17 to provide additional support.

The D-shaped outdoor cooking grill 1 straddles the seven sided top member of frame 3 and is prevented from becoming dislodged from the frame 3 laterally by the brackets 6a and 6b as shown in FIG. 7. The frame 3 upon which rests the D-shaped outdoor cooking grill 1 rests on the bottom ring 13 and is supported by a plurality of notched shaped supports (not shown) which connects the top seven sided member 17 and the bottom ring 13 of the frame 3. The bottom ring 13 provides stability to the frame 3. The notched shaped supports (not shown) also enable the grill master to raise and lower the D-shaped outdoor cooking grill 1 to a position closer or further away from the coal bed. The frame 3 is further stabilized by a plurality of bottom cross members 16 and top support members 18 which run perpendicular to cross member 10.

The components of the extendable outdoor cooking grill are shown in FIG. 8. The D-shaped outdoor cooking grill 1 is shown in extended position and rests on the seven sided top member 17 of the frame 3. The frame is connected and stabilized by the removable cross member 10 and fixed cross member 9 (not shown). The seven sided top member 17 rests on the top support members 18 by a plurality of U shaped supports 8. The seven sided top member 17 is connected to the bottom ring 13 by the notched supports 14. The frame 3 is additionally supported and stabilized by a plurality of bottom cross members 16 which extend from one side of the bottom ring 13 to the other.

The mechanism by which the seven sided top member 17 of the frame is interconnected to the remainder of the frame 3 is shown in FIG. 9. The seven sided top member 17 is stabilized by a cross member 10 which extends from one side of the seven sided top member 17 to the other side. The cross member 10 is connected to either side of the seven sided top member 17 by a hook 11a which extend through a loop 11c. The opposite end of cross member 10 is attached to the seven sided top member 17 in identical fashion. The seven sided top member 17 rests on top support members 18 on the frame 3 by a plurality of U shaped brackets 8 spaced on the underside of the seven sided top member 17 to provide support. The seven sided top member 17 is elevated above the top support members 18 by extensions 15 approximately 1 inch in length which extend from the U shaped brackets 8 to the seven sided top member 17 and which slidably connects the seven sided top member 17 to the top support members 18 of frame 3.

Another perspective of the extendable outdoor cooking grill is shown in FIG. 10. The D-shaped outdoor cooking grill 1 rests on the seven sided top member 17 prevented from becoming laterally displaced by brackets 6a. The seven sided top member 17 is supported on the top support members 18 by a plurality of U shaped supports 8 located on the underside of the seven sided top member 17 to provide support to the D-shaped outdoor cooking grill 1. The seven sided top member 17 is raised above the top support members 18 of the frame 3 by extensions 15 which connect the U shaped supports 8 to the seven sided top member 17. The seven sided top member 17 may be raised or lowered by using the notched supports 14 which also support the seven sided member 17 and connect the seven sided member 17 with the bottom ring 13. An angled support element 12 is attached to a U shaped support 8 to prevent the seven sided top member 17 from becoming displaced from the top support member 18 of the frame 3.

The invention disclosed herein is subject to many modifications, including different sizes, additional modifications or accessories. The extendable outdoor cooking grill may also be configured for use in any number of outdoor cookers. All of these embodiments are included within this specification and as further described by the appended claims.

We claim:

1. An extendable outdoor cooking grill which fits inside of an outdoor cooker and which permits the grill master to slide the extendable outdoor cooking grill to allow access to cooking grills positioned below the extendable outdoor cooking grill or to the source of heat comprising:
a supporting frame configured to fit inside a Kamodo style cooking grill;
a seven sided top member configured to fit inside a Kamodo style cooking grill and slidably moves in a parallel direction to said supporting frame and is connected to said supporting frame;
a D-shaped cooking grill configured to fit inside a Kamodo style cooking grill and which is positioned on top of said seven sided top member.
